(19) United States
(12) Patent Application Publication
(10) Pub. No.: US 2017/0349405 A1
(43) Pub. Date: Dec. 7, 2017

(54) ELEVATOR BRAKE MONITORING

(71) Applicant: Inventio AG, Hergiswil (CH)

(72) Inventor: Urs Ammon, Ebikon (CH)

(21) Appl. No.: 15/537,452

(22) PCT Filed: Dec. 18, 2015
(86) PCT No.: PCT/EP2015/080391

§ 371 Date: Jun. 19, 2017

(30) Foreign Application Priority Data
Dec. 19, 2014 (EP) 14199272.7

(51) Int. Cl. B66B 5/00; G01N 21/94; F16D 59/00; B66B 11/00; B66B 3/00; F16D 55/22; F16D 49/16; F16D 121/12; F16D 121/22

(52) U.S. Cl. CPC B66B 5/0031; B66B 5/0025; B66B 11/00; G01N 21/94; F16D 59/00; B66B 3/002; F16D 49/16; F16D 2121/12; F16D 2121/22; F16D 55/22

(57) ABSTRACT

An elevator brake, having a rotatable component mounted to a shaft, is monitored for contamination by projecting electromagnetic radiation onto the rotatable component or onto the shaft, and receiving reflected electromagnetic radiation. If the monitored zone on the rotatable component or the shaft becomes contaminated, for example with oil or grease, the nature of the electromagnetic radiation reflected from the zone will change noticeably.

### FIELD

The present disclosure relates to elevator brakes and particularly to a method and apparatus for detecting an unsafe operating condition which could potentially result in loss of brake torque and which could subsequently lead to uncontrolled car movement.

### BACKGROUND

Typically, either a drum brake or a disc brake is provided to halt rotation of a motor shaft in traction elevators. In either case, at least one compression spring is generally employed to bias the brake into its closed or braking position and an actuator which is typically electromagnetically, hydraulically or pneumatically driven is provided to overcome the spring bias and move the brake into its open or released position, permitting the motor to commence rotation and thereby raise or lower an elevator car along a hoistway. These brakes are regarded as fail-safe systems since if, for example, power is lost to the actuator, the brakes under the influence of the biasing springs automatically assume the braking or closed position.

The disc or drum is splined or otherwise mounted to the shaft for concurrent rotation therewith. The shaft itself is rotatably supported via bearings provided in one or more support brackets. Depending on the specific application, the rated speed of shaft will vary widely depending on application, but generally the shaft may have a rated speed ranging from the tens to the hundreds of revolutions per minute. Furthermore, substantial loads are transmitted by the shaft, through the bearings and to the support brackets. Given the high work duty performed by the bearing, it is beneficial to lubricate them on a regular basis with oil or grease to ensure correct functionality and prolong lifespan.

Generally, the bearings are lubricated by a technician during call-outs or routine maintenance. However, given the manual nature of the task there is an inherent possibility that the bearings may be over-lubricated. This can pose an issue as any excess oil or grease may migrate onto the shaft and, given the high centrifugal forces operating thereupon, can consequently contaminate the disc or drum leading to loss of brake torque and the possibility of uncontrolled car movement.

JP-A-2013147279 discloses a system for monitoring the thickness of a brake lining within an elevator or conveyor. In a first example, featuring a brake disc arranged between an armature and a side plate, laser light is projected axially by a sensor from the side plate onto a zone of the armature which is circumferentially outwards from the brake disc. The sensor measures the time taken for the light to be reflected back to it from the zone and from the measured time can determine the axial distance between the armature and the side plate and thereby the thickness of the brake linings attached to opposing sides of the disc. In the brake drum arrangement of a second example, the sensor is mounted externally to a brake shoe so that it projects light through holes in the shoe and brake lining onto the brake surface on the drum. Again by measuring the time taken for the light to travel from the sensor to the brake surface of the drum and back to the sensor, the sensor can determine the thickness of the brake lining.

In a similar arrangement to the second example summarized above, WO-A1-2012/101091 describes a distance sensor mounted to the brake pad which projects electromagnetic radiation onto the brake surface of the drum and determines from the reflected radiation the distance travelled. The sensor has to be insensitive to most common duct, humidity, oil film and oil vapor.

Due to the location of the sensors of JP-A-2013147279 and WO-A1-2012/101091, they firstly cannot monitor for contamination such as any excess oil or grease that may migrate onto the shaft and, given the high centrifugal forces operating thereupon, that may consequently contaminate the disc or drum leading to loss of brake torque and the possibility of uncontrolled car movement. Furthermore, due to the very nature of the sensors used in JP-A-2013147279 and WO-A1-2012/101091, they cannot determine whether any contamination has occurred in the sensed zone as the sensor of JP-A-2013147279 relies purely on the time it takes for the light to travel to determine distance and the likewise sensor of WO-A1-2012/101091 needs to be insensitive to contamination.

EP-A1-1930275 describes an apparatus for detecting whether there is an abnormality in the operation of an elevator, and in one embodiment, a detector is provided for measuring a change in a pressure or viscosity of the oil injected into a bearing for rotatably supporting a rotating shaft.

The pressure sensors disclosed in EP-A1-1930275 may not be suitable for installation in an existing elevator installation.

### SUMMARY

An objective of the present invention therefore is to provide an alternative solution for use in an elevator installation to detect an unsafe operating condition, which could potentially result in loss of brake torque and which could subsequently lead to uncontrolled car movement. The invention is, in particular, suited to the detection of over-lubrication of a bearing within the elevator.

In the method, an elevator brake having a rotatable component mounted to a shaft is monitored for contamination by projecting electromagnetic radiation onto the rotatable component or onto the shaft, and receiving reflected electromagnetic radiation. If an area or zone monitored by these steps becomes contaminated for example with oil or grease, the nature of the electromagnetic radiation reflected from the zone will change noticeably.

The degree of contamination step may be determined from the intensity of one or both of the projected and reflected electromagnetic radiations.

Preferably, a signal indicative of the intensity of the reflected electromagnetic radiation is compared with one or more thresholds. The signal may exceed an upper threshold indicating the presence of oil, grease or other contaminants. The signal may fall below a lower threshold indicating a fault with equipment.

Alternatively, a difference between the signal indicative of the intensity of the reflected electromagnetic radiation and a signal indicative of the projected electromagnetic radiation can be determined and again compared with one or more thresholds.

In either case, an elevator control can be informed if a threshold has been breached. It in turn can undertake remedial action. For example, the control can safely park an elevator car at a landing and open elevator doors to enable any passengers in the car to disembark. Furthermore, the control may also take the effected elevator out of commission and issue an alarm to a remote monitoring center indicating the situation and the need for maintenance.

The elevator installation according to the present invention comprises a shaft rotatably supported by a bearing, a brake having a rotatable component mounted to the shaft and a movable component to selectively engage a brake surface on the rotatable component, and a sensor projecting electromagnetic radiation onto and receiving reflected electromagnetic radiation from a zone located between the bearing and the brake surface. Again, the nature of the electromagnetic radiation reflected from the zone will change noticeably and dramatically as soon as the monitoring zone becomes contaminated.

Typically, the zone may be on the rotatable component or on the shaft. There is therefore a wide range of possibilities for selecting an appropriate position for mounting the sensor.

Preferably, the sensor included a transmitter, a receiver and a comparator. The comparator can either compare a signal indicative of the intensity of the reflected electromagnetic radiation with one or more thresholds or compare differences between the signal indicative of the intensity of the reflected electromagnetic radiation and a signal indicative of the projected electromagnetic radiation with one or more thresholds in order to detect an unsafe operating condition. In such a case, it is beneficial that the comparator is connected to an elevator control so that the control can undertake remedial action which may include informing a remote monitoring center.

The elevator brake can generally take any conventional form. For example, in one embodiment, the rotatable component is a brake disc and the movable component is a brake pad. Alternatively, the rotatable component could be a brake drum where the movable component is a brake lining.

Preferably, the movable component is biased by springs into engagement with the brake surface.

The movable component may be moved out of engagement with the brake surface by a hydraulic actuator or by an electromagnetic actuator.

Preferably, the electromagnetic radiation is in the form of ultraviolet light with the sensor being an ultraviolet sensor. Ultraviolet radiation has the benefit of being extremely good at exposing changes to the surface characteristics of the monitoring zone, particularly with regard to reflectivity and luminescence.

### DESCRIPTION OF THE DRAWINGS

The invention is herein described by way of specific examples with reference to the accompanying drawings of which:

FIG. 1 is a schematic illustration of an exemplary embodiment of a typical elevator installation incorporating a method and apparatus according to the present invention;

FIGS. 2A and 2B illustrate a plan and a side view, respectively, of an exemplary embodiment of a hydraulically actuated, elevator disc brake in conjunction with a sensor according to a first embodiment of the present invention;

FIGS. 3A and 3B illustrate a plan and a side view, respectively, of an exemplary embodiment of an electromagnetically actuated, elevator drum brake in conjunction with a sensor according to a second embodiment of the present invention;

FIG. 4 illustrates components with a sensor according to an exemplary embodiment of the invention;

FIG. 5 is an exemplary graphical representation over time of the signal from the receiver to the comparator depicted in FIG. 4; and

FIGS. 6A and 6B are flowcharts illustrating monitoring procedures according to exemplary embodiments of the invention.

### DETAILED DESCRIPTION

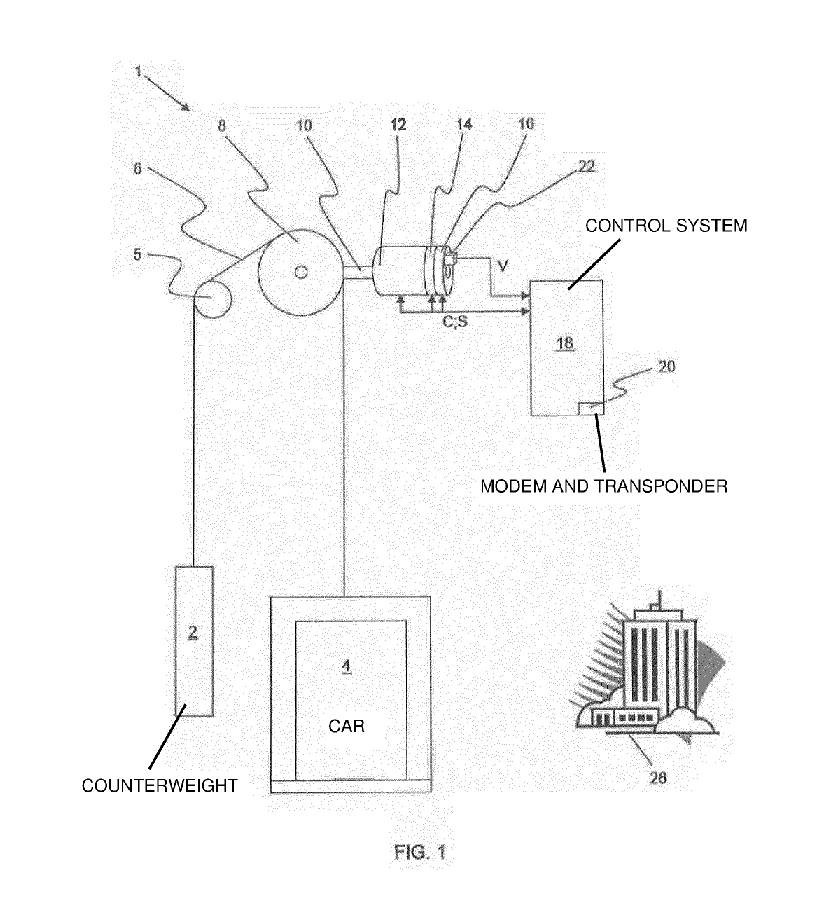

A typical elevator installation 1 for use with the method according to the invention is shown in FIG. 1. The installation 1 is generally defined by a hoistway bound by walls within a building wherein a counterweight 2 and car 4 are movable in opposing directions along guide rails. Suitable traction means 6 supports and interconnects the counterweight 2 and the car 4. In the present embodiment, the weight of the counterweight 2 is equal to the weight of the car 4 plus 40% of the rated load, which can be accommodated within the car 4. The traction means 6 is fastened to the counterweight 2 at one end, passed over a deflecting pulley 5 positioned in the upper region of the hoistway, passed through a traction sheave 8 also located in the upper region of the hoistway, and fastened to the elevator car 4. Naturally, the skilled person will easily appreciate other roping arrangements are equally possible.

The traction sheave 8 is driven via a drive shaft 10 by a motor 12 and braked by at least one elevator brake 14, 16. The use of at least two brake sets is compulsory in most jurisdictions (see, for example, European Standard EN81-1:1998 12.4.2.1). Accordingly, the present example utilizes two independent, brakes 14 and 16. Each of the brakes 14, 16 includes a spring-biased brake shoe releasable against a corresponding disc or drum mounted to the shaft 10 of the motor 12. The brake may be hydraulically actuated to counteract the force of the biasing springs. Alternatively, the brake may include an electromagnet to open the brake against the springs.

Actuation of the motor 12 and release of the brakes 14, 16 is controlled and regulated by command signals C from a control system 18. Additionally, signals S representing the status of the motor 12 and the brakes 14, 16 are continually fed back to the control system 18. Movement of the drive shaft 10 and thereby the elevator car 4 is monitored by an encoder 22 mounted on brake 16. A signal V from the encoder 22 is fed to the control system 18 permitting it to determine travel parameters of the car 4 such as position, speed and acceleration.

The control system 18 incorporates a modem and transponder 20 permitting it to communicate with a remote monitoring center 26. Such communication can be wirelessly over a commercial cellular network, through a conventional telephone network or by means of dedicated line.

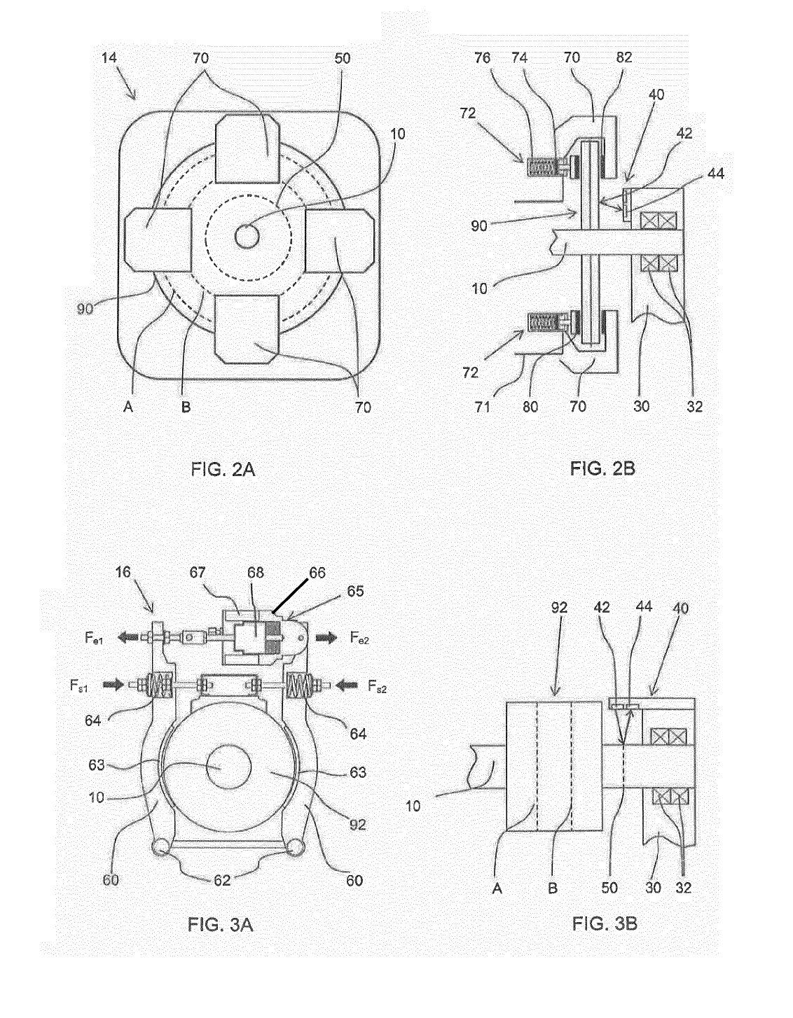

FIGS. 2A and 2B illustrate a plan and a side view, respectively, of an exemplary embodiment of a hydraulically actuated, elevator disc brake 14 in conjunction with a sensor 40 according to a first embodiment of the present invention. Within the brake 14, a brake disc 90 is splined or otherwise mounted to the shaft 10 for concurrent rotation therewith. The shaft 10 is rotatably supported via bearings 32 provided in one or more brackets 30. A plurality of hydraulic brake actuators 70 surround and overlap the disc 90.

In order to release the brake 14, pressurized fluid is supplied via hydraulic circuits 71 to a brake cylinder 72 within each actuator 70. The pressurized fluid acts on one side of a brake piston 74 to counteract the biasing force of a compression spring 76 acting on the other side of the piston 74. Accordingly as the pressure of the fluid increases, the piston 74 moves to further compress the spring 76 (in the left direction in FIG. 2B) and thereby releases a piston mounted brake shoe 80 and an opposing brake shoe 82 from engagement with the opposing sides of a brake disc 90.

Conversely, when the pressurized fluid within the hydraulic circuits 71 is drained, the pressure of the fluid with the brake cylinders 72 is no longer sufficient to counteract the biasing force of the compression springs 76 and the brake piston 74 and brake shoes 80, 82 will reassume their original positions to halt rotation of the brake disc 90 and thereby brake the shaft 10 of the elevator drive.

A brake surface A-B on the disc 90 against which the piston mounted brake shoe 80 and an opposing brake shoe 82 engage is defined as the area between the discrete circles A and B indicated in FIG. 2A.

In order to detect any material that could possibly contaminate the brake surface A-B of the disc 90, for example excess oil or grease migrating towards the brake disc 90 from the bearings 32, a sensor 40 is provided which in this example is mounted on the support bracket 30. The sensor 40 includes a transmitter 42 generating and directing ultraviolet light to a monitoring zone on the disc 90. In this instance the monitoring zone is indicated with the dashed circle 50 in FIG. 2A and is located on the disc 90 between the shaft 10 and brake surface A-B. The sensor 40 also includes a receiver 44 to capture ultraviolet light reflected from the monitoring zone 50.

Accordingly, migration of any oil or grease from the bearings 32, along the shaft 10, and radially outwards over the disc 90 and onto the monitoring zone 50, will be detected by the sensor 40 as the characteristics of the ultraviolet light reflected from the monitoring zone 50 to the a receiver 44 will change noticeably as soon as the monitoring zone 50 become contaminated.

A further exemplary embodiment of the present invention will be descried with reference to FIGS. 3A and 3B which illustrate a plan and a side view, respectively, of an electromagnetically actuated, elevator drum brake 16 in conjunction with a sensor 40.

The brake 16 includes a brake drum 92 either mounted directly on a shaft 10 either directly connected to a motor 12 or, alternatively, indirectly connected thereto via a gear. As in the previous embodiment, the shaft 10 is rotatably supported via bearings 32 provided in one or more brackets 30.

Two brake arms 60 are provided at opposing sides of the drum 92 and are mounted at their lower ends on pivots 62 connected to a housing of either the motor 12 or the gear. Each arm 60 is fitted with a brake lining 63 and is biased by a pre-tensioned compression spring 64 towards the drum 92. The forces imposed on the brake arms 60 by the springs 64 are illustrated by the arrows Fₛ₁ and Fₛ₂, respectively. An electromagnetic actuator 65 is provided between and interconnects the upper ends of the brake arms 60. The actuator 65 includes a housing 66 containing a series of solenoid coils 67 and a movable solenoid plunger 68 extending from the housing 66.

In the closed position of the brake 16, the electromagnetic actuator 65 is de-energized and therefore unable to resist the inward biasing forces Fₛ₁ and Fₛ₂ of the brake springs 64 on the arms 60. Accordingly, the brake linings 63 frictionally engage with a brake surface A-B (defined between the dashed lined A and B in FIG. 3B) on the drum 92 to either halt rotation of the shaft 10 or retain the shaft 10 in a stationary position.

When the electromagnetic actuator 65 is activated or energized, as instructed by an elevator controller 18 (see FIG. 1), current flows through the solenoid coils 67, which results in the further extension of the solenoid plunger 68 from the housing 66. This provides electromagnet opening forces illustrated by the arrows Fₑ₁ and Fₑ₂, respectively, acting on the opposing brake arms 60. The electromagnetic opening forces Fₑ₁ and Fₑ₂ open the brake 16 by further compressing the springs 64 to overcome the spring bias Fₛ₁ and Fₛ₂ and move the arms 60 and linings 63 away from the drum 92, resulting in the provision of an air gap between the brake linings 63 and the drum 92 and thereby permitting rotation of the shaft 10.

In order to detect any material that could possibly contaminate the brake surface A-B of the drum 92, for example excess oil or grease migrating towards the brake drum 92 from the bearings 32, a sensor 40 is provided, which in this example is mounted on the support bracket 30. The sensor 40 again includes a transmitter 42 generating and directing ultraviolet light to a monitoring zone which in this instance is provided on the shaft 10. The monitoring zone is indicated with the dashed circle 50 in FIG. 3B and is located on the shaft 10 between the bearings 32 and the brake surface A-B. The sensor 40 also includes a receiver 44 to capture ultraviolet light reflected from the monitoring zone 50.

Accordingly, migration of any oil or grease from the bearings 32, along the shaft 10, and onto the monitoring zone 50, will be detected by the sensor 40 as the characteristics of the ultraviolet light reflected from the monitoring zone 50 to the a receiver 44 will change noticeably as soon as the monitoring zone 50 becomes contaminated.

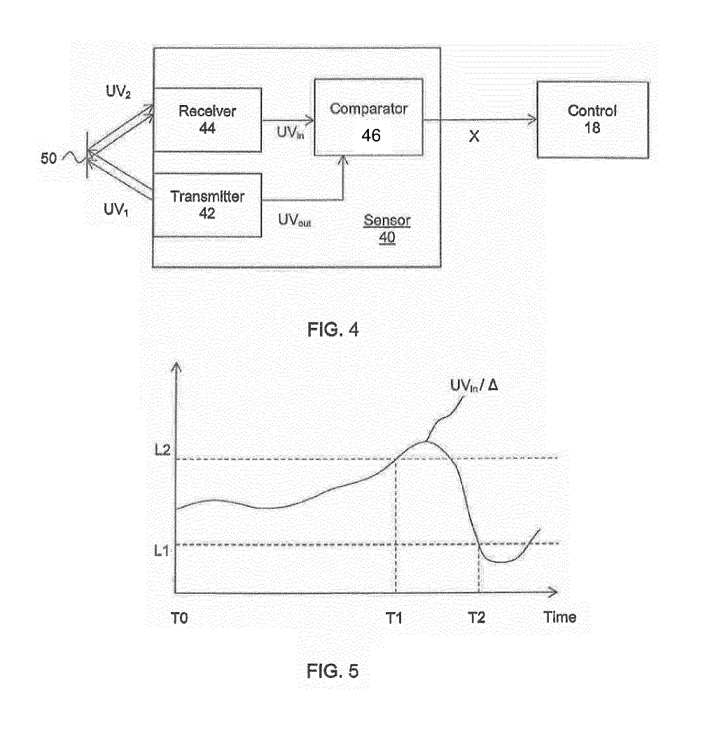

FIG. 4 illustrates the components of the sensor 40 according to an exemplary embodiment of the invention. As previously discussed, ultraviolet light UV₁ is sent from the transmitter 42 and incident upon the monitoring zone 50. Thereafter ultraviolet light UV₂ is reflected from the monitoring zone 50 to the receiver 44. The intensity of the reflected light UV₂ will naturally depend on the prevailing surface characteristics of the monitoring zone 50.

The receiver 44 generates a signal UVᵢₙ that is indicative of the intensity of the light UV₂ reflected back to it from the monitoring zone 50. This signal UVᵢₙ is fed from the receiver 44 to a comparator 46, which compares it against an upper threshold value L1 and a lower threshold value L2 to determine whether there is an unsafe operating condition, which could potentially result in loss of brake torque. If an unsafe operating condition is detected, the comparator 46 issues a signal X to the elevator control 18 which, if required, will undertake remedial action.

An example is illustrated graphically in FIG. 5 which shows the level of the signal UVᵢₙ over time. Initially, from time T0 to T1, the signal UVᵢₙ remains within the boundaries defined by the upper threshold L2 and the lower threshold value L1.

At time T1, however, the signal UVᵢₙ exceeds the upper threshold L2 possibly indicating that oil or grease has migrated onto the monitoring zone 50. In this instance, the comparator would issue a signal X to the elevator control 18 which, in response, may safely park the elevator car 4 at an appropriate landing and open elevator doors to enable any passengers in the car 4 to disembark. The control 18 may also take the effected elevator 1 out of commission and issue an alarm to the remote monitoring center 26 indicating the situation and the need for maintenance, e.g. cleaning off excessive oil or grease by a service technician.

At time T2 in the graph of FIG. 5, the signal UVᵢₙ drops below the lower threshold L1, which could indicate that the light path between the transmitter 42 and the receiver 44 is obscured, perhaps by contamination to a lens of the transmitter 42 or receiver 44. It could also indicate that at least one of the transmitter 42 and the receiver 44 is faulty. In this instance, the comparator would issue a signal X to the elevator control 18 which, in response, may issue an alarm to the remote monitoring center 26 indicating the situation and the need for maintenance.

As an alternative to the procedure described above, it is possible to determine whether there is an unsafe operating condition, which could potentially result in loss of brake torque by determining a difference Δ between the signal UVᵢₙ indicative of the intensity of the reflected ultraviolet light and a signal UVₒᵤₜ indicative of the projected ultraviolet light. Again, as in the previous procedure, if the difference Δ falls outside of the boundaries defined by an upper threshold and a lower threshold, the elevator control 18 can be informed and, if required, undertake remedial action.

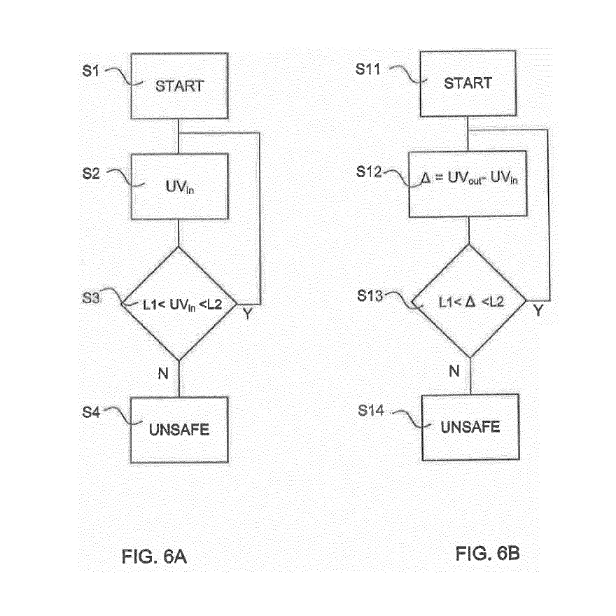

The two alternate procedures outlined above for monitoring the brake illustrated in the flowcharts of FIGS. 6A and 6B. Monitoring is commenced in step S1 when the sensor 40 is initiated to transmit ultraviolet light UV₁ onto and receive ultraviolet light UV₂ reflected back from the monitoring zone 50. In step S2, a signal UVᵢₙ indicative of the intensity of the ultraviolet light UV₂ reflected back from the monitoring zone 50 is determined. Next, in step S3, the signal UVᵢₙ is compared with an upper threshold L2 and a lower threshold L1. If the signal UVᵢₙ lies within the threshold boundaries the procedure loops back to step S2. If not, the procedure in step S4 notifies the control 18 that an unsafe condition has arisen with the brake.

In the alternate procedure shown in FIG. 6B, monitoring is commenced in step S11 when the sensor 40 is initiated to transmit ultraviolet light UV₁ onto and receive ultraviolet light UV₂ reflected back from the monitoring zone 50. In step S12, a difference Δ between a signal UVₒᵤₜ indicative of the intensity of the ultraviolet light UV₂ transmitted to the monitoring zone 50 and a signal UVᵢₙ indicative of the intensity of the ultraviolet light UV₂ reflected back from the monitoring zone 50 is determined. Next, in step S13, the difference Δ is compared with an upper threshold L2 and a lower threshold L1. If the difference Δ lies within the threshold boundaries the procedure loops back to step S12. If not, the procedure in step S14 notifies the control 18 that an unsafe condition has arisen with the brake.

The procedure outlined can be performed continuously while the elevator in operation, or can be performed periodically.

Ultraviolet light has the benefit that it is extremely good at exposing changes to the surface characteristics of the monitoring zone 50, particularly reflectivity and luminescence. However, it will be readily appreciated that other forms of electromagnetic radiation can be utilized by the invention.

Although in the exemplary embodiments specifically illustrated in FIGS. 2B and 3B the sensor 40 is mounted to the support bracket 30, it will be easily appreciated that the sensor 40 can be mounted on any component so as the zone 50, which it monitors is positioned between the bearings 32 and the braking surface A-B.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A method of monitoring contamination of an elevator brake having a rotatable component mounted to a shaft, comprising the steps of:
projecting electromagnetic radiation onto a monitoring zone located on the rotatable component or on the shaft;
providing a sensor for receiving reflected electromagnetic radiation resulting from reflection of the projected electromagnetic radiation from the monitoring zone; and
determining a degree of contamination from an intensity of at least one of the projected electromagnetic radiation and reflected electromagnetic radiations.

16. The method according to claim 15 wherein the step of determining the degree of contamination includes comparing a signal indicative of the intensity of the reflected electromagnetic radiation with at least one threshold.

17. The method according to claim 16 including, if the at least one threshold is breached, performing at least one of steps of informing an elevator control that the at least one threshold is breached, moving an elevator car associated with the elevator brake to a landing, and taking the elevator car out of commission.

18. The method according to claim 15 wherein the step of determining the degree of contamination includes determining a difference between a signal indicative of the intensity of the reflected electromagnetic radiation and a signal indicative of the intensity of the projected electromagnetic radiation.

19. The method according to claim 18 including a step of comparing the difference with at least one threshold.

20. The method according to claim 19 including, if the at least one threshold is breached, performing at least one of steps of informing an elevator control that the at least one threshold is breached, moving an elevator car associated with the elevator brake to a landing, and taking the elevator car out of commission.

21. The method according to claim 20 including a step of issuing an alarm to a remote monitoring center indicating a situation of the elevator brake and a need for maintenance.

22. An elevator installation comprising:
a shaft rotatably supported by a bearing;
a brake having a rotatable component mounted to the shaft and a movable component for selectively engaging a brake surface on the rotatable component; and
a sensor projecting electromagnetic radiation onto a monitoring zone and receiving reflected electromagnetic radiation from the monitoring zone, the monitoring zone being located between the bearing and the brake surface.

23. The elevator installation according to claim 22 wherein the monitoring zone is on the rotatable component or on the shaft.

24. The elevator installation according to claim 22 wherein the sensor includes a transmitter for projecting the electromagnetic radiation, a receiver for receiving the reflected electromagnetic radiation and a comparator connected for receiving signals from the transmitter and the receiver.

25. The elevator installation according to claim 24 wherein the comparator is connected to an elevator control that is in communication with a remote monitoring center.

26. The elevator installation according to claim 22 wherein the movable component is biased by springs into engagement with the brake surface.

27. The elevator installation according to claim 22 wherein the movable component is moved out of engagement with the brake surface by a hydraulic actuator or by an electromagnetic actuator.
